(19) United States
(12) Patent Application Publication
(10) Pub. No.: US 2010/0161987 A1
(43) Pub. Date: Jun. 24, 2010

(54) DOWNLOADABLE CONDITIONAL ACCESS SYSTEM SERVICE PROVIDING APPARATUS AND METHOD

(75) Inventors: Heejeong KIM, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/613,652

(22) Filed: Nov. 6, 2009

(30) Foreign Application Priority Data
Dec. 22, 2008 (KR) 10-2008-0131042

(51) Int. Cl. H04L 9/00

(52) U.S. Cl. 713/169

(57) ABSTRACT

Provided is a Downloadable Conditional Access System (DCAS) service providing method where a mutual authentication with respect to a DCAS host and an Authentication Proxy (AP) server is performed, operating environment information and host identification information, which are extracted by the AP server, are transmitted by the AP server to a Personalization Server (PS), image information is selected by referring to the host identification information, the operating environment information, and policy information agreed to by a Conditional Access System (CAS) server and the PS, the image information being transmitted by the PS to a code download server, and the image information is transmitted to the DCAS host, when access information of the image information is transmitted to the DCAS host through the PS and the AP server.

### CROSS-REFERENCE TO RELATED APPLICATION

This application claims priority from Korean Patent Application No. 10-2008-0131042, filed on Dec. 22, 2008, in the Korean Intellectual Property Office, the entire disclosure of which is incorporated herein by reference.

### BACKGROUND OF THE INVENTION

1. Field of the Invention

The present invention relates to a Downloadable Conditional Access System (DCAS) service providing apparatus and method, and more particularly, to a DCAS service providing apparatus and method that may confirm whether an authorized host is subscribed to a fee-based broadcasting service, and transmit an appropriate conditional access application program to provide a DCAS service.

2. Description of Related Art

A Conditional Access System (CAS) may provide only an authorized viewer with an authority to be provided with a fee-based broadcasting service. A terminal of a CAS, that is, a Conditional Access (CA) module, may manage a CA key and decrypt an encrypted received signal using the CA key.

In a CAS applied to a digital cable broadcasting in a conventional art, a CA module may be embodied as a cable card. However, a Downloadable Conditional Access System (DCAS) is provided due to disadvantages of the cable card such as a high cost and inefficiency when an accident occurs. Since a CA application program, which is software functioning as a CA module, may be securely downloaded to an authorized subscriber terminal, a DCAS may enable a subscriber to be provided with a CA service and enable a service provider to remotely configure or reset a CA scheme.

A terminal downloading a common CA image after authentication is completed in a DCAS may be considered as a terminal where a cable card is installed in a CAS in a conventional art.

A CAS master key is to be stored in a terminal, and a CAS is required to transmit an Entitlement Management Message (EMM) based on the master key, to provide the terminal with a CA service. That is, a method of transmitting a CAS master key to a subscriber terminal of a fee-based broadcasting service and a method of reflecting an authority to receive a CA service in the EMM are required.

In a CAS system in a conventional art, a CAS service provider may directly provide a CAS master key to a subscriber terminal, and simultaneously reflect an authority to the CAS master key in the EMM. In a DCAS, however, a CAS master key may be provided to a terminal through the DCAS as opposed to a CAS service provider. Also, a user of the terminal may be a subscriber or a person who desires to subscribe to a fee-based broadcasting service.

Accordingly, a method of providing a master key to an authorized terminal in a DCAS system and a method of enabling a CAS service provider managing an EMM to recognize CAS master key information included in each subscriber terminal are required.

### SUMMARY OF THE INVENTION

The present invention provides a DCAS service providing apparatus and method that may guarantee independence of a CAS service provider.

The present invention also provides a DCAS service providing apparatus and method that may distribute a conditional access key to a CAS service provider.

The present invention also provides a DCAS service providing apparatus and method that may reduce an adhesion with a DCAS service platform of a CAS service provider, and thereby may guarantee independence.

The present invention also provides a DCAS service providing apparatus and method that may maintain a management authority of a CAS service provider associated with a CAS image.

According to an aspect of the present invention, there is provided a Downloadable Conditional Access System (DCAS) service providing apparatus, including: an Authentication Proxy (AP) server to perform a mutual authentication with respect to a DCAS host; a Personalization Server (PS) to receive operating environment information and host identification information from the AP server based on the mutual authentication, and to select image information by referring to the host identification information, the operating environment information, and policy information agreed to by a Conditional Access System (CAS) server and the PS, the operating environment information and host identification information being extracted by the AP server; and a code download server to receive the image information from the PS, and to transmit the image information to the DCAS host, when access information of the received image information is transmitted to the DCAS host through the PS and the AP server.

According to an aspect of the present invention, there is provided a DCAS service providing method, including: performing a mutual authentication with respect to an AP server and a DCAS host; transmitting, by the AP server, operating environment information and host identification information to a PS based on the mutual authentication, the operating environment information and host identification information being extracted by the AP server; selecting, by the PS, image information by referring to the host identification information, the operating environment information, and policy information agreed to by a CAS server and the PS; transmitting, by the PS, the image information to a code download server; and transmitting the image information to the DCAS host, when access information of the received image information is transmitted to the DCAS host through the PS and the AP server.

According to another aspect of the present invention, there is provided a DCAS service providing method, including: connecting to a DCAS host; confirming host identification information and operating environment information of the DCAS host; determining whether the DCAS host is subscribed to a fee-based CAS broadcasting service as a result of the confirmation; selecting image information corresponding to the host identification information, when the DCAS host is subscribed to the fee-based CAS broadcasting service; setting a person-to-person transmission as a transmission scheme of the image information; uploading the image information to the DCAS host through a code download server; and providing download access information of the fee-based CAS broadcasting service to the DCAS host.

According to still another aspect of the present invention, there is provided a DCAS service providing method, including: determining policy information by agreeing on whether to support a fee-based CAS broadcasting service between a CAS server and a DCAS headend; generating image information using the CAS server, and transmitting the image information to the DCAS headend; performing a mutual authentication between the DCAS headend and a DCAS host, and transmitting host identification information and version information by the DCAS host to the DCAS headend; selecting the image information using the DCAS headend, and transmitting the selected information to the DCAS host; determining whether the DCAS host is subscribed to the fee-based CAS broadcasting service of the CAS server based on the policy information, the fee-based CAS broadcasting service corresponding to the image information; and providing, by the DCAS headend, the DCAS host with the fee-based CAS broadcasting service, when the DCAS host is subscribed to the fee-based CAS broadcasting service of the DCAS server.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a configuration of a Downloadable Conditional Access System (DCAS) service providing apparatus according to an embodiment of the present invention;

FIG. 2 is a diagram illustrating information transmitted by a Conditional Access System (CAS) server to a Personalization Server (PS) according to an embodiment of the present invention;

FIG. 3 is a diagram illustrating an expected service scenario and image code content corresponding to policy information according to an embodiment of the present invention;

FIG. 4 is a flowchart illustrating a DCAS service providing method according to an embodiment of the present invention;

FIG. 5 is a flowchart illustrating an operation of selecting an image in a PS and downloading to a DCAS host according to an embodiment of the present invention;

FIG. 6 is a flowchart illustrating a relationship between a time to subscribe to a fee-based CAS broadcasting service and a time when the fee-based CAS broadcasting service is available according to an embodiment of the present invention; and

FIG. 7 is a flowchart illustrating an operation of a DCAS host to use a fee-based CAS broadcasting service according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

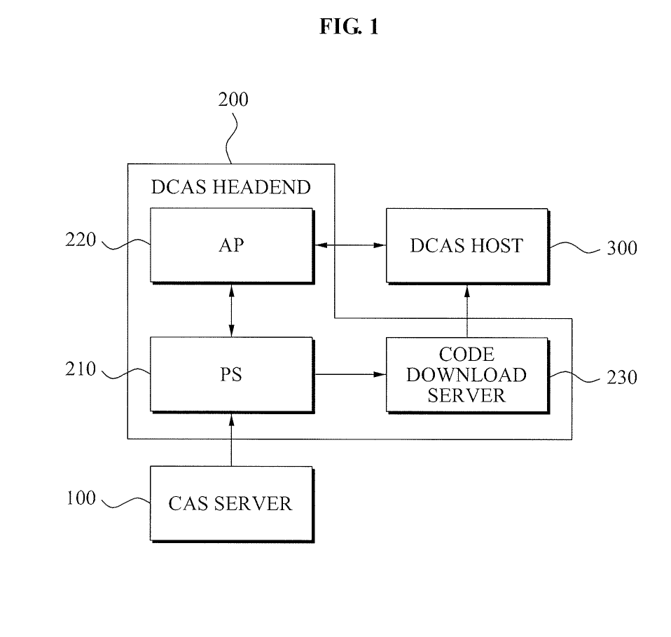

FIG. 1 is a block diagram illustrating a configuration of a Downloadable Conditional Access System (DCAS) service providing apparatus 200 according to an embodiment of the present invention.

As illustrated in FIG. 1, the DCAS service providing apparatus 200 may include an Authentication Proxy (AP) server 220, a Personalization Server (PS) 210, and a code download server 230.

According to an embodiment of the present invention, the AP 220 may be a module functioning as a DCAS server window and an authentication server with respect to a DCAS host 300. The PS 210 may be a module that may agree to control a DCAS policy in association with a CAS server 100 and manage CAS image information. Hereinafter, the CAS image information may be referred to as image information.

Also, a host authentication and CAS image information download are to be sequentially performed to provide a fee-based CAS broadcasting service to the DCAS host 300 connected to a DCAS, which is described in detail.

The CAS server 100 and the PS 210 may determine policy information by politically agreeing to whether to support a DCAS host subscribed to a fee-based CAS broadcasting service, and whether to return assignment information between the DCAS host and an image information to the CAS server 100 before connecting to the DCAS.

When a pre-subscriber is supported as described above, the DCAS host 300 may download the image by connecting to the DCAS, and simultaneously use the fee-based CAS broadcasting service.

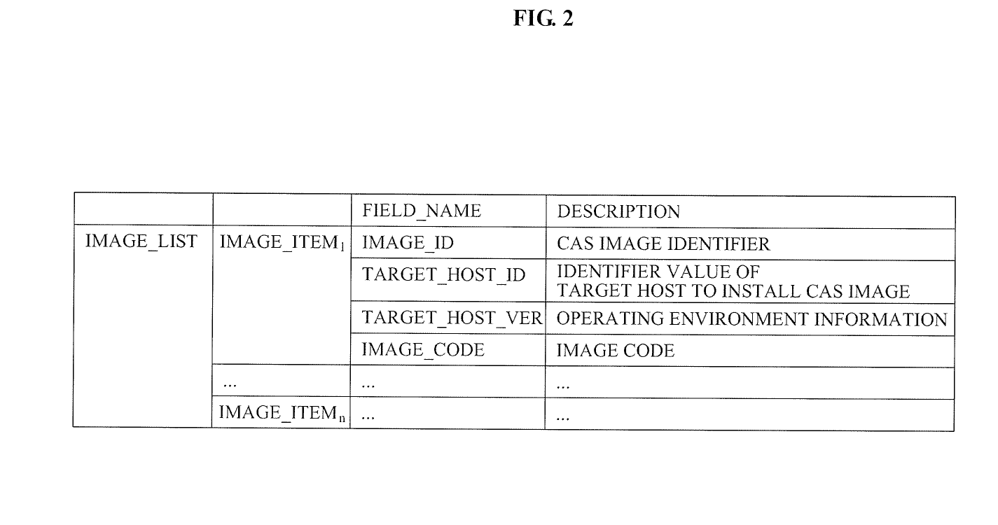

The CAS server 100 may transmit the image information, generated by the CAS server 100 itself, and related information to a DCAS headend 200. The image information and the related information are described with reference to FIG. 2.

FIG. 2 is a diagram illustrating information transmitted by a Conditional Access System (CAS) server to the PS 210 according to an embodiment of the present invention.

For example, as illustrated in FIG. 2, the image information and the related information may include Image_Id, Target_Host_Id, and the like. The Image_Id may indicate a CAS image identifier, and the Target_Host_Id may indicate an identifier value of a target host to install the image information.

When the target host is a single host, the CAS server 100 may have a designated value as the Target_Host_Id or be marked in blank. When the target host is all hosts, the CAS server 100 may mark ‘COMMON’ as the Target_Host_Id, and transmit to the PS 210.

Also, according to an embodiment of the present invention, the CAS server 100 may independently determine whether to include conditional access key information and target host determination information in the image information. The CAS server 100 may control the DCAS headend 200 to transmit an image code to an authorized host, and prevent the DCAS headend 200 from ascertaining content of the image code.

Also, according to an embodiment of the present invention, the CAS server 100 may affect or control content of the image information, selection of the DCAS host 300, and a DCAS service scenario, based on the policy information.

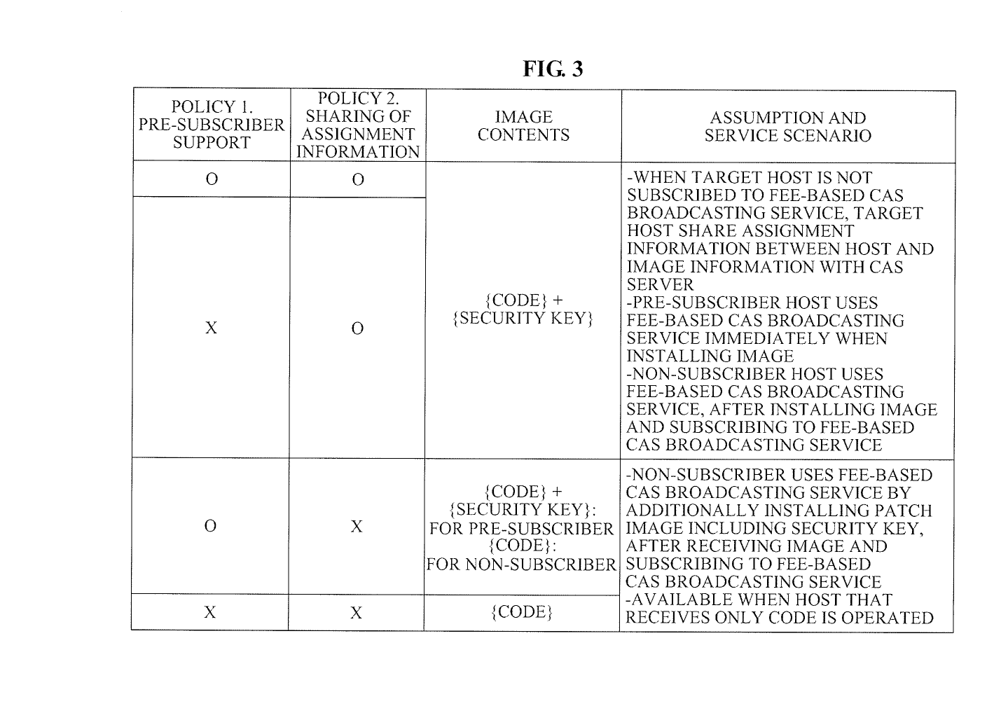

FIG. 3 is a diagram illustrating an expected service scenario and image code content corresponding to policy information according to an embodiment of the present invention.

For example, as illustrated in FIG. 3, when whether to support a pre-subscriber is agreed to based on the policy information is positive, when whether to share image assignment information is agreed to based on the policy information is also positive, and when the content of the image information is ‘{code}+{security key}’, a target host may share assignment information between the target host and image information with a CAS server, when the target host is a non-subscriber of a fee-based CAS broadcasting service assuming that all DCAS hosts are for the fee-based CAS broadcasting service.

In this instance, according to an embodiment of the present invention, a host of the pre-subscriber may install the image information and simultaneously use the fee-based CAS broadcasting service. A host of the non-subscriber may use the fee-based CAS broadcasting service, after installing the image information and subscribing to the fee-based CAS broadcasting service.

An AP server 220 may perform a mutual authentication with respect to a DCAS host 300.

In this instance, the AP server 220 may obtain host identification information, operating environment information, an authentication key, and the like during the mutual authentication. Also, the AP server 220 may transmit the obtained information to a PS 210.

The PS 210 may receive the host identification information and the operating environment information, extracted by the AP server 220 based on the mutual authentication, from the AP server 220. Also, the PS 210 may select the image information by referring to the host identification information, the operating environment information, and the policy information agreed to by the CAS server 100 and the PS 210.

In this instance, the PS 210 may support the policy information with respect to the DCAS host 300, and when image information corresponding to the host identification information exists, may immediately select the image information.

However, the PS 210 may support the policy information with respect to the DCAS host 300, and when image information corresponding to the host identification information does not exist, may select preliminary image information by referring to the operating environment information.

Also, the PS 210 may determine any one of a person-to-person transmission and a multiplex transmission as a transmission scheme of the image information by referring to the policy information.

As described above, the image information, selected by the PS 210, may be transmitted to a code download server 230.

The code download server 230 may receive the image information from the PS 210, and transmit the image information to the DCAS host 300, when access information of the received image information is transmitted to the DCAS host 300 through the PS 210 and the AP server 220.

In this instance, the access information may include a file name of the image information, server connection information, and the like. The server connection information may indicate an Internet Protocol (IP) address of a server in a person-to-person transmission scheme, and indicate channel information in a multiplex transmission scheme.

When the image information is received, the DCAS host 300 may install and set the image information in the DCAS host 300, and use the fee-based CAS broadcasting service.

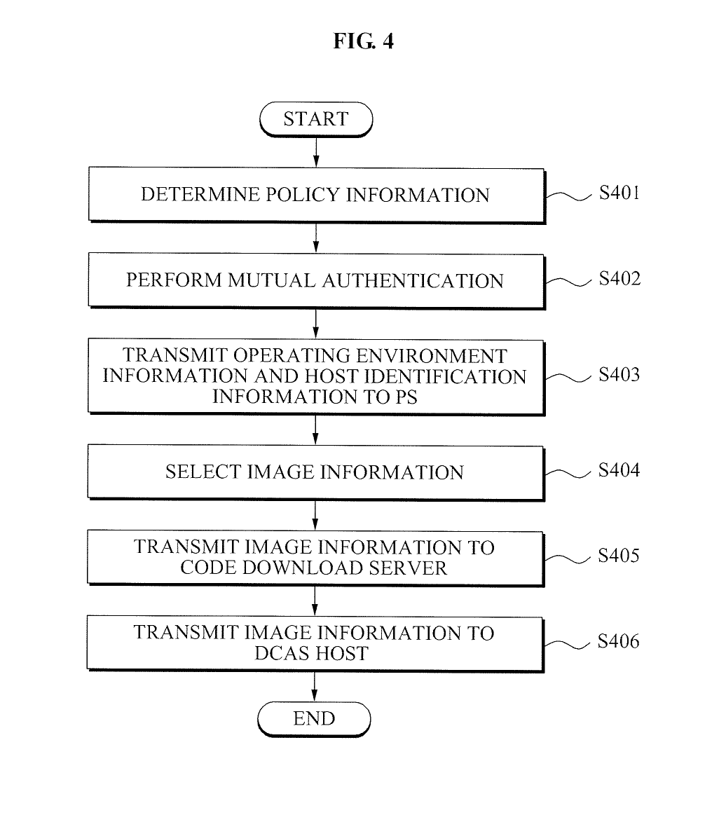

A DCAS service providing method according to an embodiment of the present invention is described with reference to FIG. 4.

FIG. 4 is a flowchart illustrating a DCAS service providing method according to an embodiment of the present invention.

In operation S401, a PS 210 and a CAS server 100 may determine policy information by politically agreeing to whether to support a DCAS host 300 subscribed to a fee-based CAS broadcasting service, and whether to return assignment information between the DCAS host 300 and an image to the CAS server 100 in advance.

In this instance, the CAS server 100 may generate and transmit image information to the PS 210.

In operation S402, a mutual authentication may be performed between an AP server 220 and the DCAS host 300.

In operation S403, the AP server 220 may transmit operating environment information and host identification information to the PS 210 based on the mutual authentication. The operating environment information and the host identification information may be extracted by the AP server 220.

In operation S404, the PS 210 may select image information by referring to the host identification information, the operating environment information, and policy information agreed on by the CAS server 100 and the PS 210.

In operation S405, the PS 210 may transmit the image information to a code download server 230.

In operation S406, the code download server 230 may transmit the image information to the DCAS host 300, when access information of the received image information is transmitted to the DCAS host 300 through the PS 210 and the AP server 220.

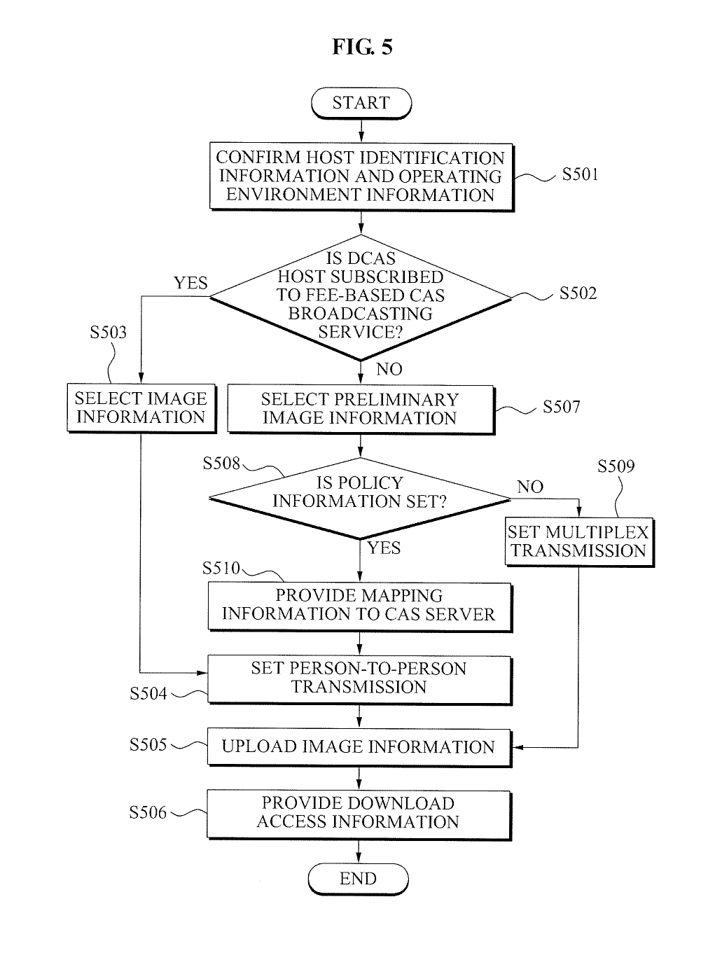

The PS 210 may select the image information to be transmitted to an authorized DCAS host, determine a transmission scheme, and upload the information to the code download server 230 to return the access information to the AP server 220, which is described with reference to FIG. 5.

FIG. 5 is a flowchart illustrating an operation of selecting an image in a PS 210 and downloading to a DCAS host 300 according to an embodiment of the present invention.

In operation S501, the PS 210 may confirm the host identification information and operating environment information of the DCAS host 300 while the PS 210 is connected to the DCAS host 300.

In operation S502, the PS 210 may determine whether the DCAS host 300 is subscribed to a fee-based CAS broadcasting service as a result of the confirmation.

In operation S503, the PS 210 may select image information corresponding to the host identification information, when the DCAS host 300 is subscribed to the fee-based CAS broadcasting service.

In operation S504, the PS 210 may set a person-to-person transmission as a transmission scheme of the image information.

In operation S505, the PS 210 may upload the image information to the DCAS host 300 through the code download server 230.

In operation S506, the PS 210 may provide download access information of the fee-based CAS broadcasting service to the DCAS host 300.

In operation S507, when the DCAS host 300 is not subscribed to the fee-based CAS broadcasting service, the PS 210 may select preliminary image information corresponding to the operating environment information.

In operation S508, the PS 210 may determine whether policy information associated with sharing of image assignment information of the DCAS host 300 is set.

In operation S509, when the policy information associated with sharing of the image assignment information of the DCAS host 300 is not set, the PS 210 may set a multiplex transmission as the transmission scheme of the image information.

Also, the PS 210 may perform the uploading in operation S505 and the providing in operation S506.

In operation S510, the policy information associated with sharing of the image assignment information of the DCAS host is set, and the PS 210 may provide mapping information to a CAS server 100.

Also, the PS 210 may perform the setting in operation S504, the uploading in operation S505, and the providing in operation S506.

As described above, a DCAS service providing apparatus may support a variety of service scenarios. When a CAS service provider politically supports, the DCAS host 300 may subscribe to the fee-based CAS broadcasting service before accessing a DCAS headend 200, and thereby may download image information and simultaneously use the fee-based CAS broadcasting service.

When the CAS service provider politically does not support, the DCAS host 300 may subscribe to the fee-based CAS broadcasting service after downloading the image information from the DCAS headend 200. In this instance, the fee-based CAS broadcasting service may be used right after the subscription, or after additionally downloading patch image information after the subscription, according to policy information of the CAS service provider.

That is, a time when the fee-based CAS broadcasting service is available may be determined based on the image information, provided by the CAS service provider, and a time to subscribe to the fee-based CAS broadcasting service.

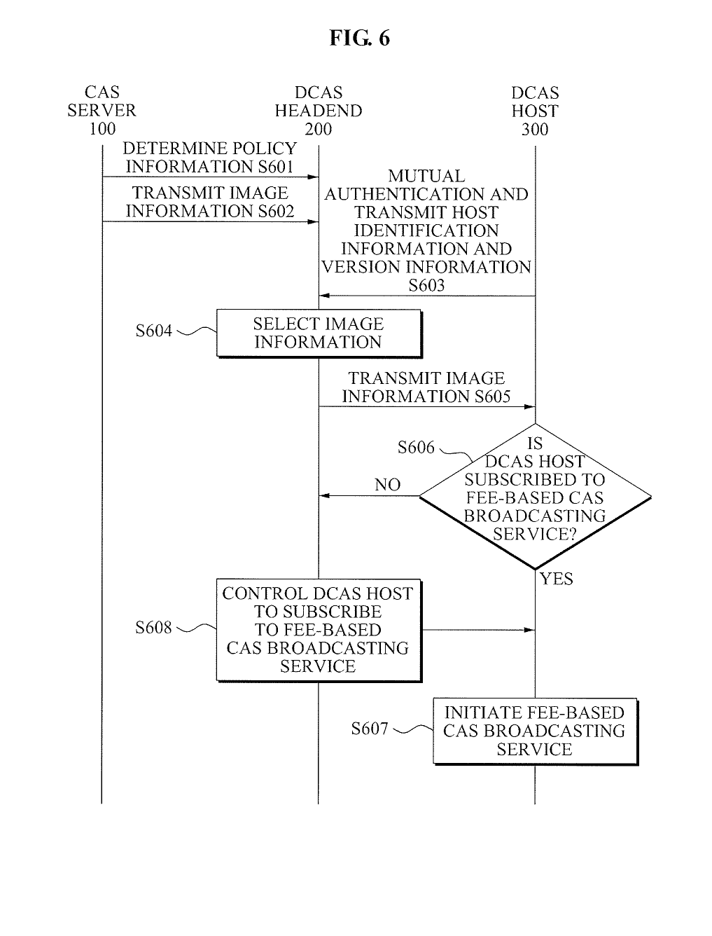

FIG. 6 is a flowchart illustrating a relationship between a time to subscribe to a fee-based CAS broadcasting service and a time when the fee-based CAS broadcasting service is available according to an embodiment of the present invention.

In operation S601, a CAS server 100 and a DCAS headend 200 may determine policy information by an agreement on whether to support a fee-based CAS broadcasting service.

In operation S602, the CAS server 100 may generate image information, and transmit the image information to the DCAS headend 200.

In operation S603, a mutual authentication may be performed between the DCAS headend 200 and a DCAS host 300, and the DCAS host 300 may transmit host identification information and version information to the DCAS headend 200.

In operation S604, the DCAS headend 200 may select the image information. In operation S605, the DCAS headend 200 may transmit the selected image information to the DCAS host 300.

In operation S606, the DCAS host 300 may determine whether the DCAS host 300 is subscribed to the fee-based CAS broadcasting service of a DCAS server based on the policy information. The fee-based CAS broadcasting service may correspond to the image information.

In operation S607, when the DCAS host 300 is subscribed to the fee-based CAS broadcasting service, the DCAS headend 200 may provide the DCAS host 300 with the fee-based CAS broadcasting service.

In operation S608, when the DCAS host 300 is not subscribed to the fee-based CAS broadcasting service, the DCAS headend 200 may control the DCAS host 300 to subscribe to the fee-based CAS broadcasting service.

Also, when the DCAS host 300 is subscribed to the fee-based CAS broadcasting service, the DCAS headend 200 may control the DCAS host 300 to be provided with information about the fee-based CAS broadcasting service.

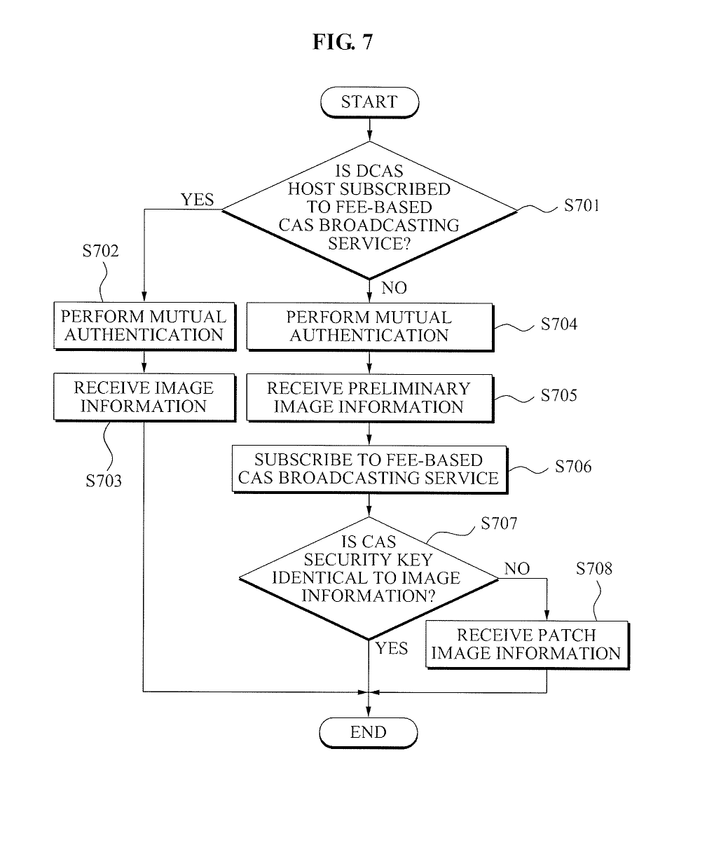

Also, a method where the DCAS host 300 uses the fee-based CAS broadcasting service is described with reference to FIG. 7.

FIG. 7 is a flowchart illustrating an operation of the DCAS host 300 to use a fee-based CAS broadcasting service according to an embodiment of the present invention.

In operation S701, it may be determined whether the DCAS host 300 is subscribed to the fee-based CAS broadcasting service.

In operation S702, when the DCAS host 300 is subscribed to the fee-based CAS broadcasting service, a mutual authentication may be performed between the DCAS host 300 and an AP server 220.

In operation S703, the DCAS host 300 may receive image information from the DCAS headend 200.

In operation S704, when the DCAS host 300 is not subscribed to the fee-based CAS broadcasting service, the mutual authentication may be performed between the DCAS host 300 and the AP server 220. In operation S705, the DCAS host 300 may receive preliminary image information. In operation S706, the DCAS host 300 may subscribe to the fee-based CAS broadcasting service.

In operation S707, it may be determined whether a CAS security key is identical to the image information. When the CAS security key is identical to the image information, the DCAS host 300 may use the fee-based CAS broadcasting service. In operation S708, when the CAS security key is not identical to the image information, the DCAS host 300 may receive patch image information including the CAS security key.

According to the present invention, a DCAS service providing apparatus and method may guarantee independence of a CAS service provider.

Also, according to the present invention, the DCAS service providing apparatus and method may distribute a conditional access key to a CAS service provider.

Also, according to the present invention, the DCAS service providing apparatus and method may reduce an adhesion with a DCAS service platform of a CAS service provider, and thereby may guarantee independence.

Also, according to the present invention, the DCAS service providing apparatus and method may maintain a management authority of a CAS service provider associated with a CAS image.

DCAS service providing method according to the above-described example embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A Downloadable Conditional Access System (DCAS) service providing apparatus, comprising:
an Authentication Proxy (AP) server to perform a mutual authentication with respect to a DCAS host;
a Personalization Server (PS) to receive operating environment information and host identification information from the AP server based on the mutual authentication, and to select image information by referring to the host identification information, the operating environment information, and policy information agreed to by a Conditional Access System (CAS) server and the PS, the operating environment information and host identification information being extracted by the AP server; and
a code download server to receive the image information from the PS, and to transmit the image information to the DCAS host, when access information of the received image information is transmitted to the DCAS host through the PS and the AP server.

2. The DCAS service providing apparatus of claim 1, wherein the PS and the CAS server determines the policy information by politically agreeing to whether to support a DCAS host subscribed to a fee-based CAS broadcasting service, and whether to return assignment information between the DCAS host and the image information to the CAS server in advance.

3. The DCAS service providing apparatus of claim 2, wherein the PS supports the policy information with respect to the DCAS host, and when image information corresponding to the host identification information exists, selects the image information.

4. The DCAS service providing apparatus of claim 2, wherein the PS supports the policy information with respect to the DCAS host, and selects preliminary image information by referring to the operating environment information when image information corresponding to the host identification information does not exist.

5. The DCAS service providing apparatus of claim 2, wherein the PS determines any one of a person-to-person transmission and a multiplex transmission as a transmission scheme of the image information by referring to the policy information.

6. The DCAS service providing apparatus of claim 2, wherein the DCAS host uses the fee-based CAS broadcasting service, when the image information is received.

7. The DCAS service providing apparatus of claim 1, wherein the CAS server generates the image information and transmits the generated image information to the PS.

8. The DCAS service providing apparatus of claim 7, wherein the CAS server independently determines whether to include conditional access key information and target host determination information in the image information.

9. The DCAS service providing apparatus of claim 1, wherein the CAS server controls content of the image information, selection of the DCAS host, and a DCAS service scenario, based on the policy information.

10. The DCAS service providing apparatus of claim 1, wherein the access information includes a file name of the image information and server connection information.

11. A DCAS service providing method, comprising:
performing a mutual authentication with respect to an AP server and a DCAS host;
transmitting, by the AP server, operating environment information and host identification information to a PS based on the mutual authentication, the operating environment information and host identification information being extracted by the AP server;
selecting, by the PS, image information by referring to the host identification information, the operating environment information, and policy information agreed to by a CAS server and the PS;
transmitting, by the PS, the image information to a code download server; and
transmitting the image information to the DCAS host, when access information of the received image information is transmitted to the DCAS host through the PS and the AP server.

12. The DCAS service providing method of claim 11, further comprising:
determining, by the PS and the CAS server, the policy information by politically agreeing to whether to support a DCAS host subscribed to a fee-based CAS broadcasting service, and whether to return assignment information between the DCAS host and an image to the CAS server in advance.

13. The DCAS service providing method of claim 11, wherein the CAS server generates the image information and transmits the generated image information to the PS.

14. A DCAS service providing method, comprising:
connecting to a DCAS host;
confirming host identification information and operating environment information of the DCAS host;
determining whether the DCAS host is subscribed to a fee-based CAS broadcasting service as a result of the confirmation;
selecting image information corresponding to the host identification information, when the DCAS host is subscribed to the fee-based CAS broadcasting service;
setting a person-to-person transmission as a transmission scheme of the image information;
uploading the image information to the DCAS host through a code download server; and
providing download access information of the fee-based CAS broadcasting service to the DCAS host.

15. The DCAS service providing method of claim 14, further comprising:
selecting preliminary image information corresponding to the operating environment information, when the DCAS host is not subscribed to the fee-based CAS broadcasting service;
determining whether policy information associated with sharing of image assignment information of the DCAS host is set; and
setting a multiplex transmission as the transmission scheme of the image information, when the policy information associated with sharing of the image assignment information of the DCAS host is not set.

16. The DCAS service providing method of claim 15, further comprising:
providing mapping information to a CAS server, when the policy information associated with sharing of the image assignment information of the DCAS host is set.

17. A DCAS service providing method, comprising:
determining policy information by agreeing on whether to support a fee-based CAS broadcasting service between a CAS server and a DCAS headend;
generating image information using the CAS server, and transmitting the image information to the DCAS headend;
performing a mutual authentication between the DCAS headend and a DCAS host, and transmitting host identification information and version information by the DCAS host to the DCAS headend;
selecting the image information using the DCAS headend, and transmitting the selected information to the DCAS host;
determining whether the DCAS host is subscribed to the fee-based CAS broadcasting service of a DCAS server based on the policy information, the fee-based CAS broadcasting service corresponding to the image information; and
providing, by the DCAS headend, the DCAS host with the fee-based CAS broadcasting service, when the DCAS host is subscribed to the fee-based CAS broadcasting service.

18. The DCAS service providing method of claim 17, further comprising:
controlling the DCAS host to subscribe to the fee-based CAS broadcasting service, when the DCAS host is not subscribed to the fee-based CAS broadcasting service; and
providing, by the DCAS headend, the DCAS host with the fee-based CAS broadcasting service, when the DCAS host is subscribed to the fee-based CAS broadcasting service.
